(19) United States
(12) Patent Application Publication
(10) Pub. No.: US 2016/0331163 A1
(43) Pub. Date: Nov. 17, 2016

(54) VACUUM ADHERING SERVING SYSTEM

(71) Applicant: Michael W. Handerhan, New York, NY (US)

(72) Inventor: Michael W. Handerhan, New York, NY (US)

(21) Appl. No.: 15/067,310

(22) Filed: Mar. 11, 2016

Related U.S. Application Data
(60) Provisional application No. 62/159,587, filed on May 11, 2015.

(51) Int. Cl. A47G 19/10; F16B 47/00; F16M 13/02

(52) U.S. Cl. CPC A47G 19/10; F16M 13/022; F16B 47/006

(57) ABSTRACT

A vacuum adhering serving system may include a vacuum cup having a suction cup and a suction aperture. The suction aperture may be coupled to a vacuum nozzle of a vacuum pump. A housing including a male container engaging element may be coupled to the vacuum cup. A serving container with a male housing engaging element and a serving surface may be coupled to the housing by coupling the male housing engaging element of the serving container to the male container engaging element of the housing. By placing the suction cup in contact with a substrate surface, such as a table top, counter top, bar top, and the like, and then actuating the vacuum pump, air may be removed from between the substrate surface and the suction cup through the vacuum nozzle to adhere the system to the substrate surface.

### CROSS REFERENCE TO RELATED APPLICATIONS

This application claims priority to and the benefit of the filing date of U.S. Provisional Application No. 62/159,587, filed on May 11, 2015, entitled “INTERLOCKING BOWL WITH PUMP AND INTEGRATED HOUSING AND CUP SYSTEM”, which is hereby incorporated by reference in its entirety.

### FIELD OF THE INVENTION

This patent specification relates to the field of food and beverage serving systems. More specifically, this patent specification relates to food and beverage serving systems that are able to adhere to surfaces.

### BACKGROUND

There are many situations in which it is desirable to provide food and beverage to an individual in a serving container that is able to resist tipping over. These situations can include feeding infants and young children, disabled adults, and the elderly. By preventing a food and beverage container from tipping over, wasting of food and beverage can be prevented and the length of feeding times may be reduced. While there have been attempts to use suction cups which are attached to food and beverage containers to prevent the containers from tipping over, many of the suction cups used for bowls in the market today fail to keep the needed suction and are easily removed or come off unexpectedly. Rather than utilizing a vacuum seal they are simply creating suction by applying pressure to whatever surface they are adhered to. Further, many of the products using suction cups and bowls come pre-attached to the bowl or plate and don't allow for interchangeable accessories such as different bowl sizes and colors.

Therefore, a need exists for novel food and beverage containers that are able to resist tipping over. There is a further need for novel food and beverage serving systems that are able to adhere to a plurality of surfaces. Finally, there exists a need for novel food and beverage serving systems that are able to accept interchangeable accessories such as different bowl sizes and colors.

### BRIEF SUMMARY OF THE INVENTION

A vacuum adhering serving system that is able to adhere to a plurality of substrate surfaces to resist tipping over is provided. In some embodiments, the system may include a vacuum cup having a suction cup and a suction aperture. The suction aperture may be coupled to a vacuum nozzle of a vacuum pump. A housing including a male container engaging element may be coupled to the vacuum cup. A serving container with a male housing engaging element and a serving surface may be coupled to the housing by coupling the male housing engaging element of the serving container to the male container engaging element of the housing. By placing the suction cup in contact with a substrate surface, such as a table top, counter top, bar top, and the like, and then actuating the vacuum pump, air may be removed from between the substrate surface and the suction cup through the vacuum nozzle to adhere the system to the substrate surface.

In further embodiments, the serving container may be removably coupled to the housing by rotating the male housing engaging element into contact with the male container engaging element to rotatably couple the housing to the serving container.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a perspective view of an example of a vacuum adhering serving system according to various embodiments described herein.

FIG. 2—FIG. 2 illustrates a side elevation view of an example of a vacuum adhering serving system adhered to a substrate surface according to various embodiments described herein.

FIG. 3—FIG. 3 shows a perspective exploded view of the front of an example of a vacuum adhering serving system according to various embodiments described herein.

FIG. 4—FIG. 4 depicts a top perspective view of an example of a vacuum cup according to various embodiments described herein.

FIG. 5—FIG. 5 illustrates a top plan view of an example of a vacuum cup according to various embodiments described herein.

FIG. 6—FIG. 6 shows a bottom perspective view of an example of a vacuum cup according to various embodiments described herein.

FIG. 7—FIG. 7 depicts a bottom plan view of an example of a vacuum cup according to various embodiments described herein.

FIG. 8—FIG. 8 illustrates a top perspective view of an example of an inner support ring according to various embodiments described herein.

FIG. 9—FIG. 9 shows a bottom perspective view of an example of an inner support ring according to various embodiments described herein.

FIG. 10—FIG. 10 depicts a perspective exploded view of an example of a vacuum pump according to various embodiments described herein.

FIG. 11—FIG. 11 illustrates a top perspective view of an example of a housing according to various alternative embodiments described herein.

FIG. 12—FIG. 12 shows a top plan view of an example of a housing according to various alternative embodiments described herein.

FIG. 13—FIG. 13 depicts a bottom perspective view of an example of a housing according to various alternative embodiments described herein.

FIG. 14—FIG. 14 illustrates a bottom plan view of an example of a housing according to various embodiments described herein.

FIG. 15—FIG. 15 shows a top perspective view of an example of a serving container according to various embodiments described herein.

FIG. 16—FIG. 16 depicts a bottom perspective view of an example of a serving container according to various embodiments described herein.

FIG. 17—FIG. 17 illustrates a top plan view of an example of a serving container according to various embodiments described herein.

FIG. 18—FIG. 18 shows a sectional, through line 18-18 shown in FIG. 17, elevation view of an example of a serving container according to various embodiments described herein.

FIG. 19—FIG. 19 depicts a bottom plan view of an example of a serving container according to various embodiments described herein.

FIG. 20—FIG. 20 illustrates a sectional, through line 20-20 shown in FIG. 19, elevation view of an example of a serving container according to various embodiments described herein.

FIG. 21—FIG. 21 shows a top plan view of an example of a lid according to various embodiments described herein.

FIG. 22—FIG. 22 depicts a bottom perspective view of an example of a lid according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

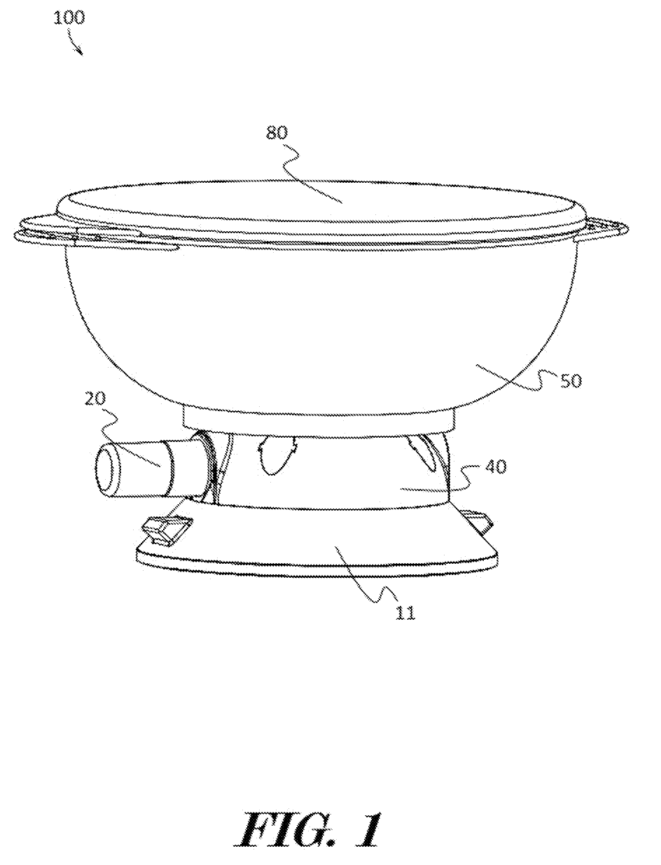

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

New food and beverage serving systems that are able to adhere to surfaces are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

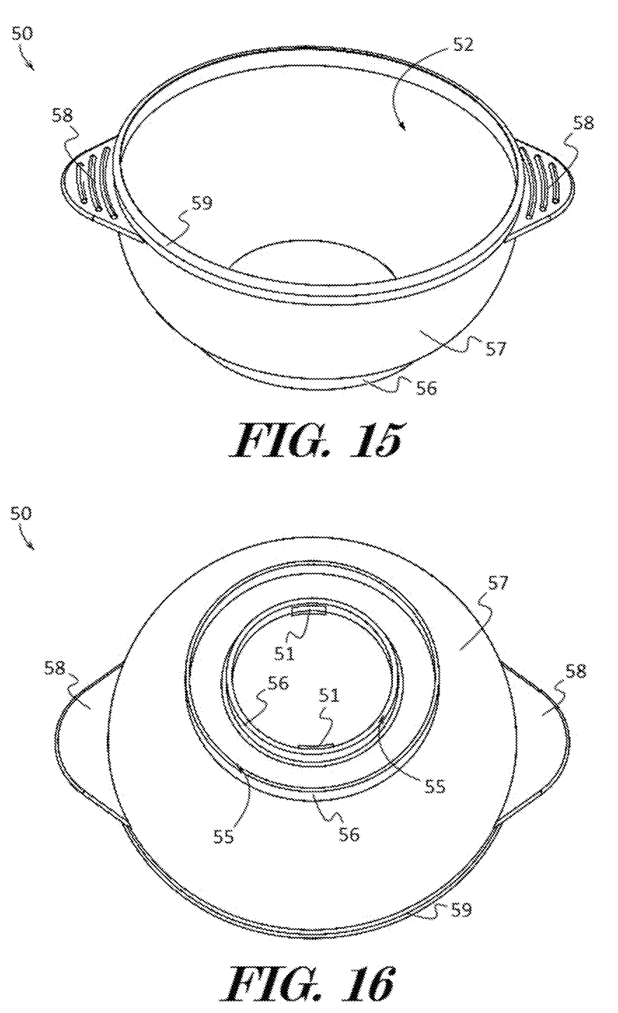

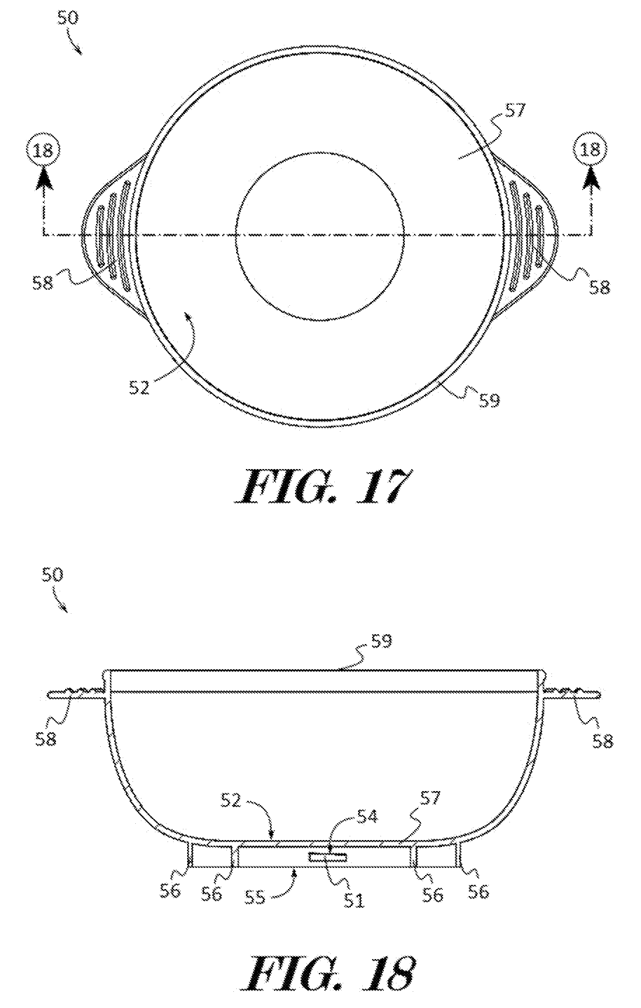

The present invention will now be described by example and through referencing the appended figures representing preferred and alternative embodiments. FIGS. 1-3 illustrate an example of a vacuum adhering serving system (“the system”) 100 according to various embodiments. In some embodiments, the system 100 may comprise a vacuum cup 11 which includes a suction cup 12 and a suction aperture 13. The suction aperture 13 may be coupled to a vacuum nozzle 21 of a vacuum pump 20. A housing 40 comprising a male container engaging element 41 may be coupled to the vacuum cup 11. A serving container 50 comprising a male housing engaging element 51 (FIG. 16, 18-20) and a serving surface 52 (FIGS. 15, 17, 18, 20) may be coupled to the housing 40 by coupling the male housing engaging element 51 of the serving container 50 to the male container engaging element 41 of the housing 40. By placing the suction cup 12 in contact with a substrate surface 200, such as a table top, counter top, bar top, and the like, and then actuating the vacuum pump 20, air may be removed from between the substrate surface 200 and the suction cup 12 to adhere the system 100 to the substrate surface 200. Preferably, the serving container 50 may be removably coupled to the housing 40, thereby allowing serving containers 50 configured as cups, bowls, plates, and the like to be interchanged and removably coupled to the housing 40.

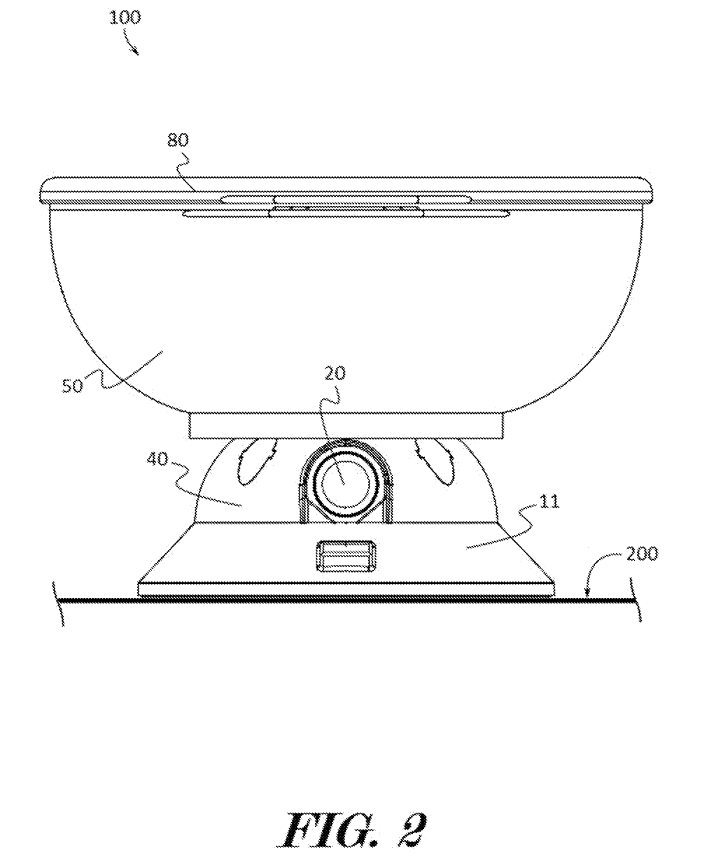

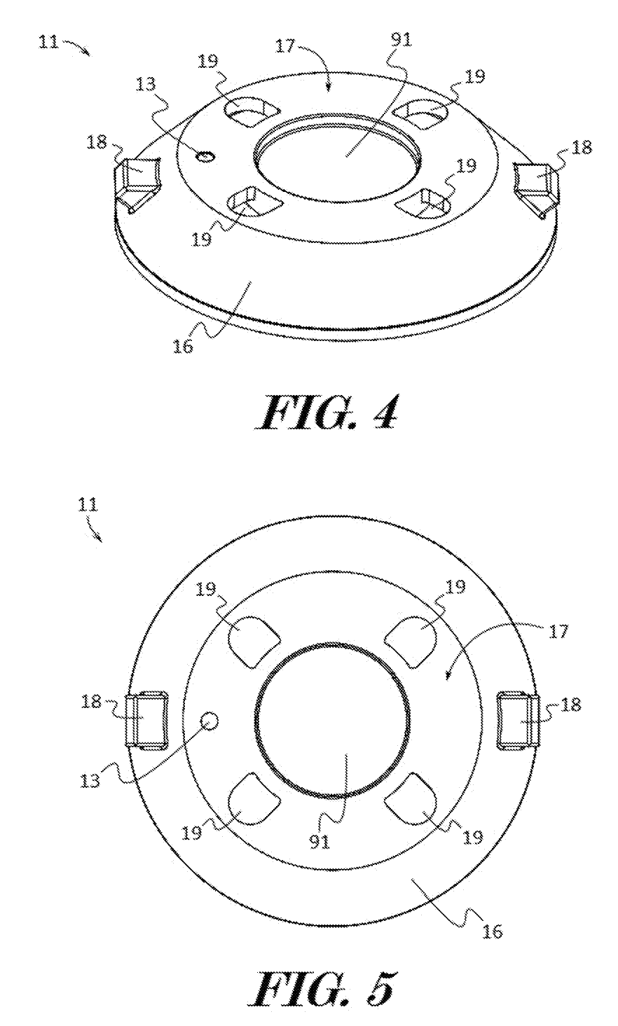

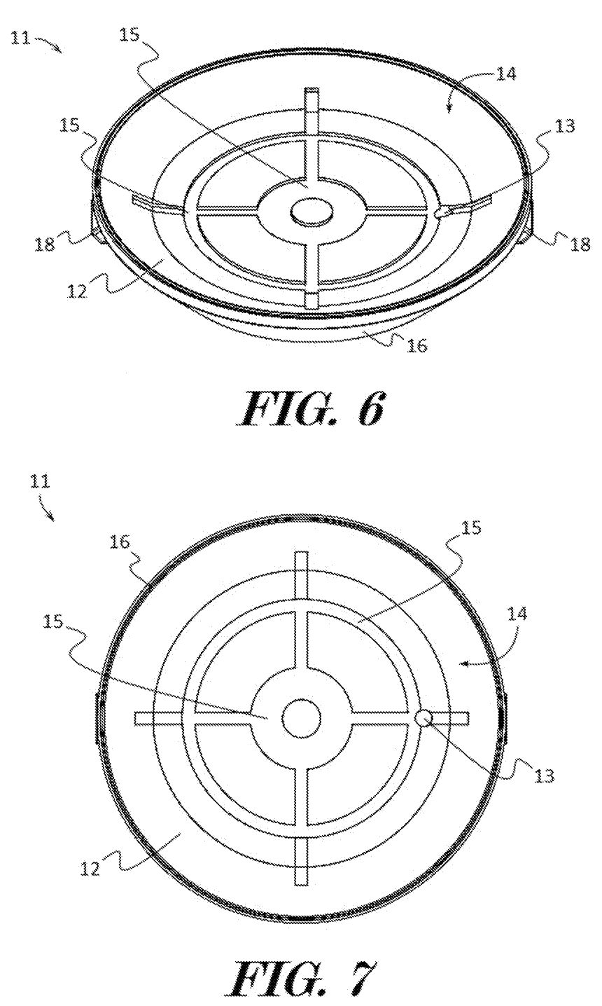

Turning now to FIGS. 4-7, an example of a vacuum cup 11 according to various embodiments is perhaps best shown. Preferably, all or portions of the vacuum cup 11 may be formed from or comprise a resilient material such as rubber, soft plastic, silicone, or any other suitable material. In some embodiments, a vacuum cup 11 may comprise one or more suction cups 12 each comprising a preferably concave suction cup surface 14. Portions of the suction cup surface 14 may be placed in contact with a substrate surface 200 (FIG. 2) to which it is desired to adhere the system 100 (FIGS. 1-3). Optionally, the suction cup surface 14 may comprise raised or indented texturing, such as one or more channels 15, ridges, and the like, which may facilitate the frictional engagement of the suction cup 12 to substrate surfaces 200.

In some embodiments, the vacuum cup 11 may comprise a skirt 16 into which the suction cup may be formed into. The skirt 16 may be joined to a mounting surface 17 to which other elements of the system 100 may be mounted or coupled, such as the housing 40 and/or vacuum pump 20. The skirt 16 may comprise one or more release tabs 18 which may be manipulated to break the suction seal between a suction cup 12 and the substrate surface 200 to which it is adhered to. The release tabs 18 may be of various sizes and shapes to allow a user to press or pull on a release tab 18 to break the suction seal of the suction cup 12. In further embodiments, the vacuum cup 11 may comprise two release tabs 18 which may be positioned on opposite sides of the vacuum cup 11, such as on opposite sides of the skirt 16.

In some embodiments, the vacuum cup 11 may comprise one or more mounting depressions 19 which may be used to couple, optionally with a fastener or adhesive, an element of the system 100, such as the housing 40 and/or vacuum pump 20, to the vacuum cup 11. In further embodiments, a mounting depression 19 may comprise a recess which may be formed into the mounting surface 17 and which may receive a portion of an inner support ring 60, housing 40, and/or vacuum pump 20. In further embodiments, a mounting depression 19 may comprise a protrusion which may be formed to extend out and away from the mounting surface 17 and which may mate with or contact a portion of an inner support ring 60, housing 40, and/or vacuum pump 20. Optionally, the vacuum cup 11 may comprise one or more reducing depressions 91 which may be complementary in shape to one or more elements of the system 100 and/or which may reduce the amount of material required to make a vacuum cup 11.

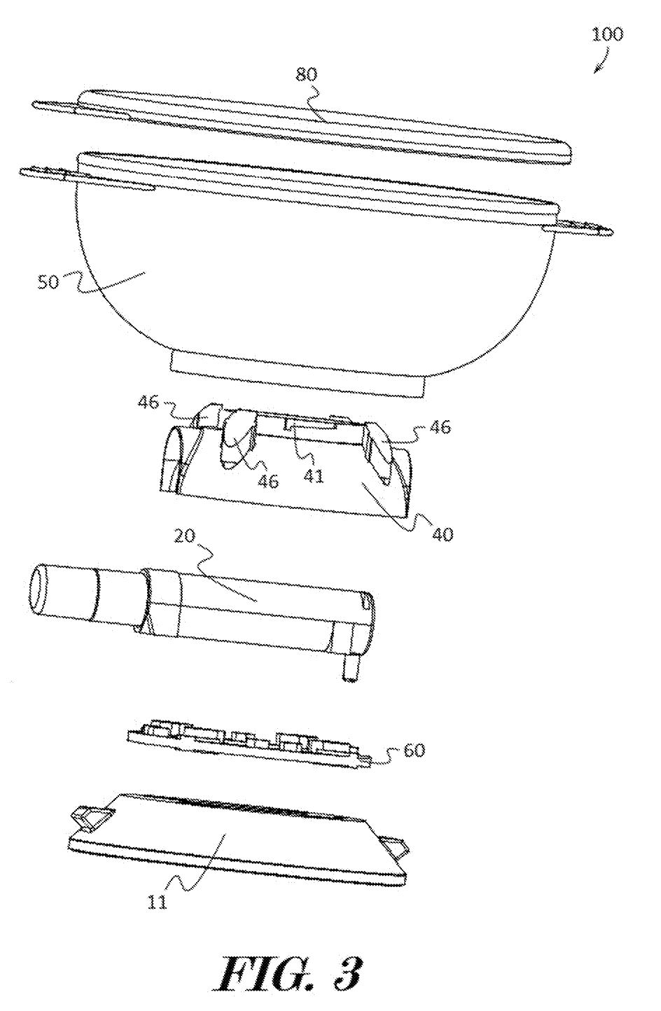

The vacuum cup 11 may comprise a suction aperture 13 which may pass through the suction cup 12 from the suction cup surface 14 to the mounting surface 16. A suction aperture 13 may allow air to be removed from within the suction cup 12. In preferred embodiments, when the suction cup surface 14 is in contact with a substrate surface 200, air may be removed from within the suction cup 12 through the vacuum nozzle 21 (FIGS. 3 and 10) of a vacuum pump 20 (FIGS. 1-3 and 10) which is coupled to the suction aperture 13.

Turning now to FIGS. 3, 8, and 9, in some embodiments, the system 100 (FIGS. 1-3) may comprise an optional inner support ring 60. An inner support ring 60 may be configured to align and/or couple one or more elements of the system 100, such as the vacuum cup 11, vacuum pump 20, and/or housing 40 together. The inner support ring 60 may comprise one or more major support protrusions 61, minor support protrusions 62, and/or support apertures 63 which may be shaped and positioned to receive a coupling element, such as a fastener or adhesive, and/or a portion of an element of the system 100, such as the vacuum cup 11, vacuum pump 20, and/or housing 40.

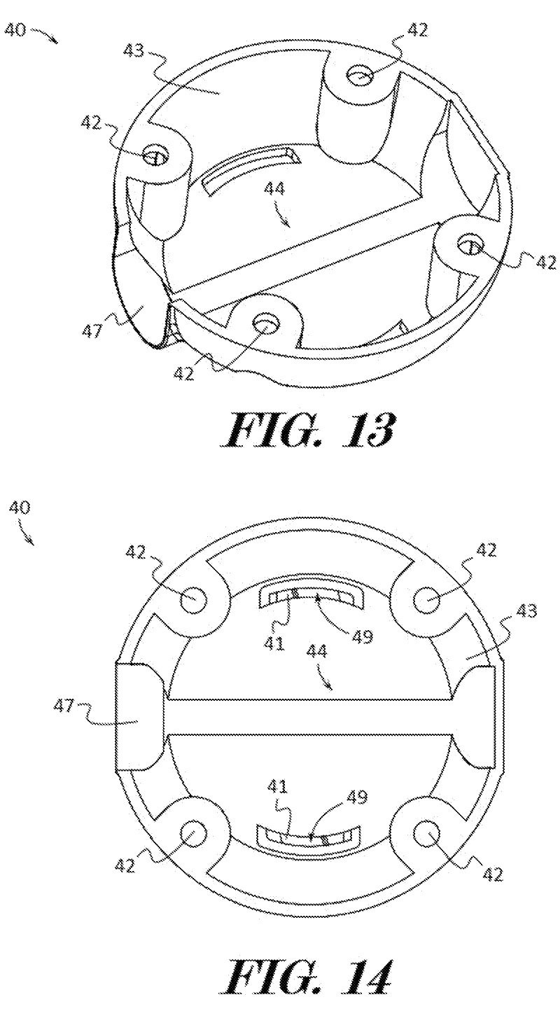

In some embodiments, the inner support ring 60 may comprise a top surface 64, bottom surface 65, inside surface 66, and an outside surface 67. The bottom surface 65 may be coupled to the mounting surface 17 of the vacuum cup 11 with each major support protrusion 61 mating with a mounting depression 19. Preferably, one or more minor support protrusions 62 of the bottom surface 65 may also contact the mounting surface 17 of the vacuum cup 11. One or more support apertures 63 of the inner support ring 60 may receive a fastener, such as a threaded fastener, which may also pass through a housing aperture 42 (FIGS. 12-14) which may couple the housing 40 to the vacuum cup 11 with the inner support ring 60 positioned between.

As perhaps best shown in FIG. 10, the vacuum pump 20 may comprise an assembly of elements which may be used to remove air from within the suction cup 12 to create a vacuum between the suction cup 12 and a substrate surface 200 with which the vacuum cup 11 is in contact with. By creating a vacuum between the suction cup 12 and a substrate surface 200, the vacuum cup 11, and therefore the system 100, may be adhered to the substrate surface 200.

Many different types of vacuum pumps comprising many different elements and assemblies may be used with the system 100 with the assembly of FIG. 10 being only exemplary in nature and is not to be construed as limiting. In some embodiments, a vacuum pump 20 may comprise a plunger housing 22 which has a vacuum nozzle 21 through which air may be removed from within the suction cup 12 through the suction aperture 13. A flap seal 23, lock ring 24, plunger tip 25, plunger seal 26, seal washer 27, a spring collar 28, and spring 29 may be contained within the plunger housing 22 by a plunger 30. By actuating the plunger 30, such as by linearly moving the plunger 30 towards and away from the plunger housing 22, air may be pulled through the vacuum nozzle 21, removed from within the suction cup 11, and prevented from returning by the flap seal 23.

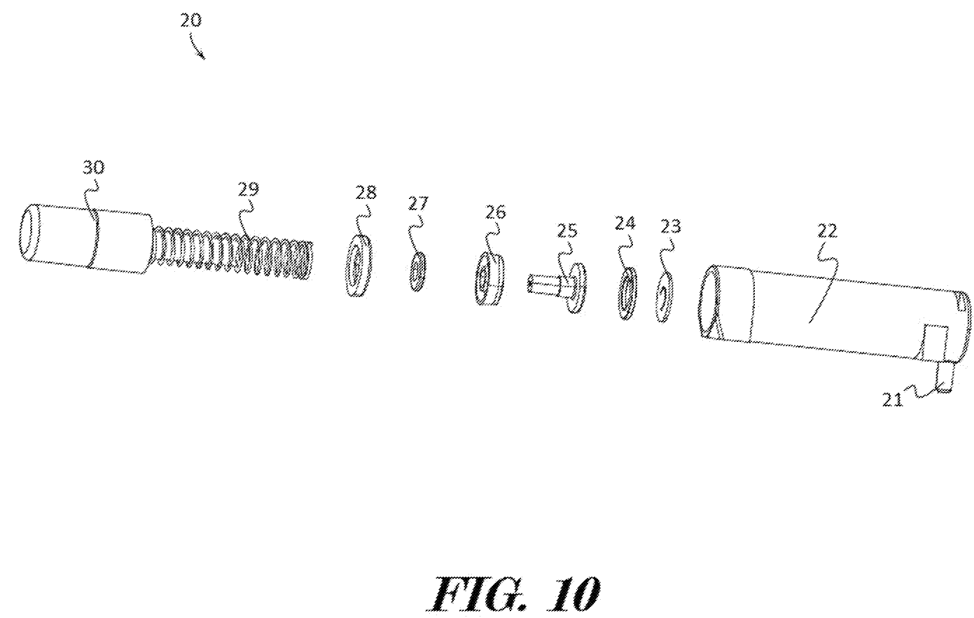

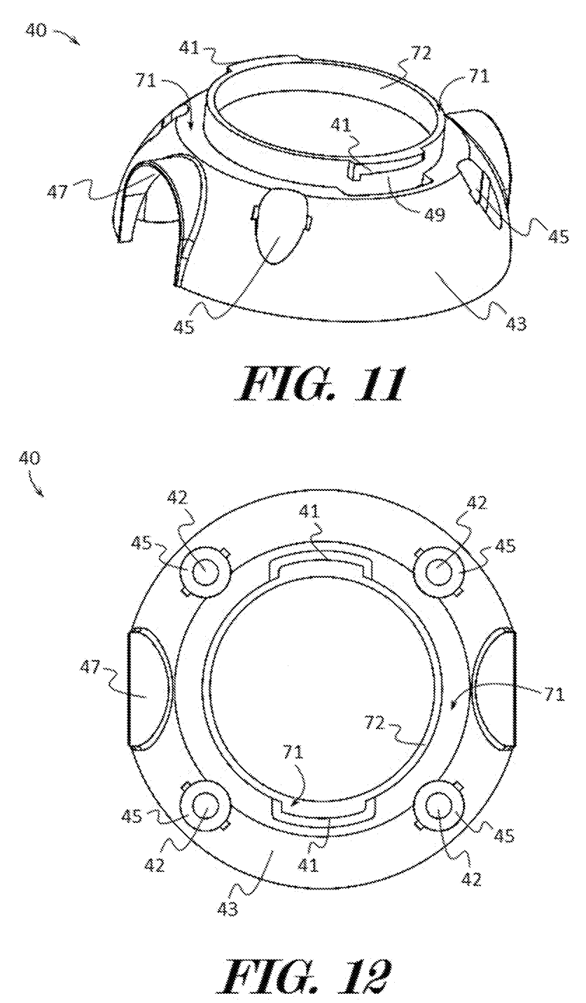

Turning now to FIGS. 11-14, an example of a housing 40 according to various embodiments is depicted. In preferred embodiments, the housing 40 may comprise a housing sidewall 43 which may form a cavity 44 which may receive portions of a vacuum pump 20 (FIGS. 1-3, and 10), such as the vacuum nozzle 21 and plunger housing 22. The housing sidewall 43 may be coupled to the vacuum cup 11 (FIGS. 1-7) and/or optionally to the inner support ring 60 (FIGS. 3, 8, and 9) thereby coupling the housing 40 to the vacuum cup 11. In further embodiments, the housing 40 may comprise one or more housing apertures 42 (FIGS. 12-14) which may be configured to receive a fastener, such as a threaded fastener, which may be inserted through a support aperture 63, mounting surface 17, and/or mounting depression 19 to couple the housing 40 to the inner support ring 60 and/or vacuum cup 11. Optionally, a housing aperture 42 may be positioned or sunk within a housing depression 45 (FIGS. 12-14) and then covered with a cap 46 (FIG. 3) that is complementary shaped to the housing depression 45 which may prevent dirt and debris from accumulating in a housing depression 45.

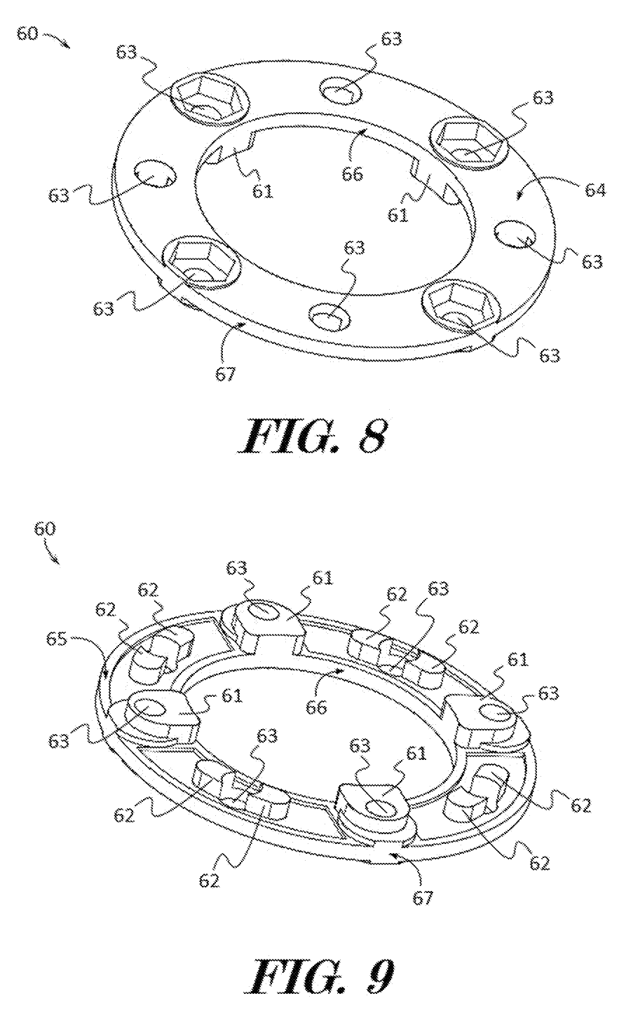

In some embodiments, the housing 40 may comprise a plunger groove 47 which may be complementary in shape to the plunger housing 22 and/or plunger 30 to allow the plunger 30 of the vacuum pump 20 to extend through the plunger groove 47 when portions of the vacuum pump 20 is received within the cavity 44 of the housing 40. In further embodiments, the vacuum pump 20 may be received within the cavity 44 so that the plunger 30 may extend through the plunger groove 47 to allow a user to actuate the plunger 30. In still further embodiments, the vacuum nozzle 21 and suction aperture 13 may be enclosed within the housing 40 such as within the cavity 44 between the housing 40, the vacuum cup 11, and optionally within the inside surface 66 (FIGS. 8 and 9) of an inner support ring 60.

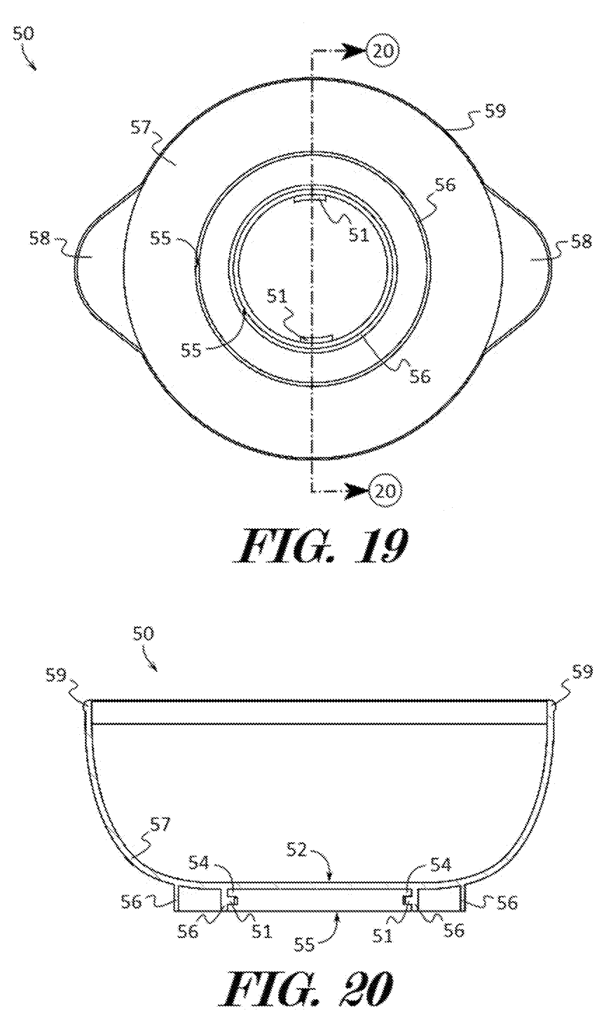

Referring to FIGS. 11, 12, 14, 16, and 18-20, in preferred embodiments, the housing 40 may be removably coupled to a serving container 50. In further preferred embodiments, the housing 40 may be removably coupled to a serving container 50 with a turn to lock connection or coupling method. In some embodiments, the housing 40 may comprise one or more male container engaging elements 41. Each male container engaging element 41 may comprise a housing sloped surface 49 which is configured to contact the container sloped surface 54 of a male housing engaging element 51 of a serving container 50 to couple the serving housing 40 to the container 50. In further embodiments, a serving container 50 may comprise one or more male housing engaging elements 51. Each male housing engaging element 51 may comprise a container sloped surface 54 which is configured to contact the housing sloped surface 49 of a male container engaging element 41 of a housing 40 to couple the serving container 50 to the housing 40. In still further embodiments, a male housing engaging element 51 may be rotated into contact with a male container engaging element 41 to rotatably couple the housing 40 to a serving container 50.

In further embodiments, a container sloped surface 54 may have a slope that is complementary to the slope of a housing sloped surface 49. Each housing sloped surface 49 and container sloped surface 54 may comprise a similar length. By rotating the serving container 50 relative to the housing 40 while the sloped surfaces 49, 54, are in contact with each other, the sloped surfaces 49, 54, may draw the serving container 50 and the housing 40 together thereby functioning as threaded coupling which is configured to convert between rotational and linear movement or force. In further embodiments, a serving container 50 may comprise a housing abutment surface 55 and the housing 40 may comprise a container abutment surface 71. The abutments surfaces 55, 71, may be positioned to come into contact with each other as the sloped surfaces 49, 54, rotate relative to each other to arrest the rotation and provide a stable engagement between the housing 40 and serving container 50.

In some embodiments, a serving container 50 may comprise one or more optional container guides 56 and the housing 40 may comprise one or more optional housing guides 72. One or more male container engaging elements 41 may be coupled to a housing guide 72 and one or more male housing engaging elements 51 may be coupled to a container guide 56. The housing guide 72 and container guide 56 may function to align the housing 40 and serving container 50 when they are brought together to facilitate the removable coupling engagement of a male container engaging element 41 with a male housing engaging element 51. In further embodiments, a housing guide 72 and/or a container guide 56 may be annular in shape.

FIGS. 15-20 show an example of a serving container 50 according to various embodiments described herein. In some embodiments, the housing 40 may be adhered to a substrate surface 200 (FIG. 2) by the vacuum cup 11 and one or more serving containers 50 may be alternately coupled to the housing 40. A serving container 50 may comprise one or more serving surfaces 52 and one or more male housing engaging elements 51. Preferably, the serving container 50 may be removably coupled to the housing 40 by removably coupling the male housing engaging element 51 of the serving container 50 to a male container engaging element 41 of the housing 40. The housing 40 may be adhered to a substrate surface 200 (FIG. 2) by the vacuum cup 11 and one or more serving containers 50 may be alternately coupled to the housing 40.

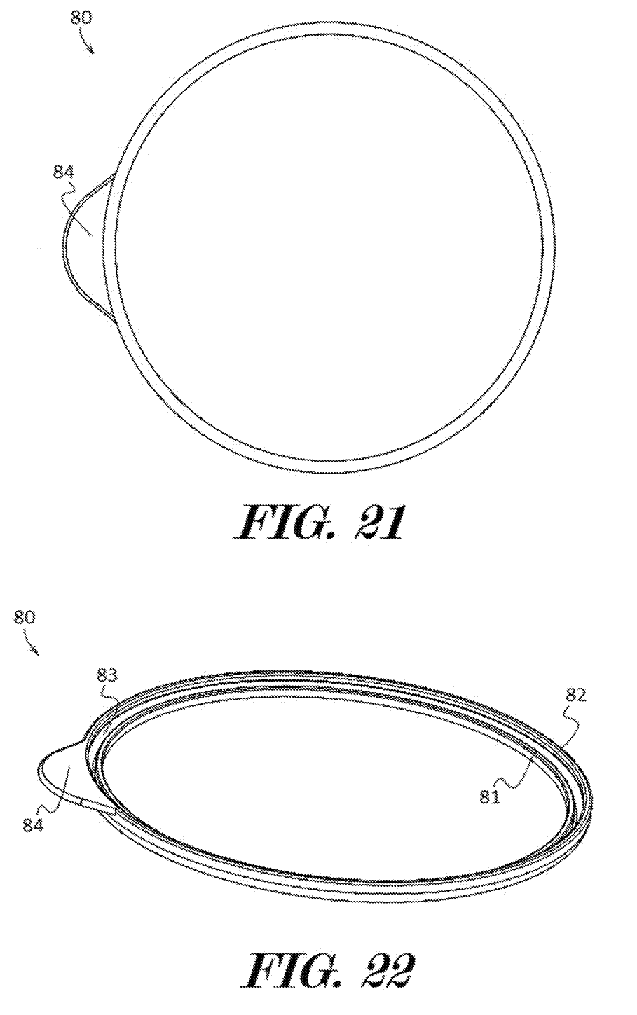

In some embodiments, a serving surface 52 may be formed by a container sidewall 57. One or more container sidewalls 57 may bound and separate one serving surface 52 from another serving surface 52. In further embodiments, the male housing engaging elements 51, container sloped surface 54, housing abutment surface 55, and optional annular container guide 56 may be molded or otherwise coupled to the container sidewall 57. Optionally, a container lip 58 may be coupled to one or more container sidewalls 57 which may be configured to be removably coupled to a lid 80 (FIGS. 21 and 22).

In some embodiments, a container sidewall 57 may extend up and away from the male housing engaging elements 51 to form a serving surface 52 which is generally bowl shaped. By extending the container sidewall 57 a greater distance from the male housing engaging elements 51 the serving surface 52 may be configured as a deeper bowl. Conversely, by decreasing the distance that a container sidewall 57 may extend from the male housing engaging elements 51 the serving surface 52 may be configured as a shallower bowl or even as a plate or serving tray. A serving container 50 may be configured in any shape or size that is able to store or dispense food and/or beverage items. The example of FIGS. 15-20 may generally resemble a bowl, however, in other embodiments, a serving container 50 may be configured as a plate, a tray, a cup, a saucer, or any other type or style of container that is able to store or dispense food and/or beverage items.

FIGS. 21 and 22 illustrate an example of a lid 80 which may be removably coupled to a serving container 50 (FIGS. 1-3, 15-20) according to various embodiments described herein. In some embodiments, a lid 80 may comprise an inner lid lip 81 and/or an outer lid lip 82. Preferably, an inner lid lip 81 and/or an outer lid lip 82 may be removably coupled to a container lip 59 (FIGS. 15-20) to removably couple a lid 80 to a serving container 50. In further embodiments, an inner lid lip 81 and an outer lid lip 82 may be spaced apart from each other to form a lid channel 83 which may be configured to frictionally engage or snap fit the container lip 59 thereby removably coupling a lid 80 to a serving container 50. In alternative embodiments, a lid 80 may be coupled to a serving container 50 with any other removably coupling or connection method.

In some embodiments, a lid 80 and/or a serving container 50 may comprise one or more grip tabs of any shaped or size which may be grasped or otherwise manipulated by a user to attach or to remove a lid 80 from a serving container 50. In further embodiments, a serving container 50 may comprise one or more serving container grip tabs 58 (FIGS. 15-20) which may be coupled to the container sidewall 57. In still further embodiments, a lid 80 may comprise one or more lid grip tabs 84 (FIGS. 21 and 22) which may be coupled anywhere on the lid 80.

While some materials have been provided, in other embodiments, the elements that comprise the system 100 such as the vacuum cup 11, vacuum pump 20, housing 40, serving container 50, optional inner support ring 60, optional lid 80, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the system 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the system 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the system 100 may be coupled by being one of connected to and integrally formed with another element of the system 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A vacuum adhering serving system, the system comprising:
a vacuum cup having a suction cup and a suction aperture;
a vacuum pump with a vacuum nozzle coupled to the suction aperture of the vacuum cup, wherein actuation of the vacuum pump removes air from within the suction cup;
a housing coupled to the vacuum cup comprising a male container engaging element; and
a serving container comprising a serving surface and a male housing engaging element, wherein the serving container is coupled to the housing by coupling the male housing engaging element of the serving container to the male container engaging element of the housing.

2. The system of claim 1, wherein the vacuum pump comprises a plunger which is actuated to removes air from within the suction cup.

3. The system of claim 1, wherein the housing comprises a plunger groove and the plunger of the vacuum pump extends through the plunger groove.

4. The system of claim 1, wherein the vacuum cup comprises a release tab.

5. The system of claim 1, wherein the vacuum cup comprises two release tabs, and wherein the release tabs are positioned on opposite sides of the vacuum cup.

6. The system of claim 1, wherein the vacuum nozzle and suction aperture are enclosed within the housing.

7. The system of claim 1, wherein the serving surface of the serving container is bowl shaped.

8. The system of claim 7, further comprising a lid configured to be removably coupled to the serving container to cover the serving surface.

9. The system of claim 1, wherein the serving container is removably coupled to the housing by removably coupling the male housing engaging element of the serving container to the male container engaging element of the housing.

10. The system of claim 9, wherein the male housing engaging element of the serving container is removably coupled to the male container engaging element of the housing with threading.

11. The system of claim 9, wherein the male housing engaging element is rotated into contact with the male container engaging element to rotatably couple the housing to the serving container.

12. A vacuum adhering serving system, the system comprising:
a vacuum cup comprising a suction cup and a suction aperture;
a vacuum pump with a vacuum nozzle coupled to the suction aperture of the vacuum cup, wherein actuation of the vacuum pump removes air from within the suction cup;
a housing coupled to the vacuum cup comprising a male container engaging element; and
a serving container comprising a male housing engaging element, wherein the serving container is removably coupled to the housing by rotating the male housing engaging element into contact with the male container engaging element to rotatably couple the housing to the serving container.

13. The system of claim 12, wherein the vacuum pump comprises a plunger which is actuated to removes air from within the suction cup.

14. The system of claim 12, wherein the housing comprises a plunger groove and the plunger of the vacuum pump extends through the plunger groove.

15. The system of claim 12, wherein the vacuum cup comprises a release tab.

16. The system of claim 12, wherein the vacuum cup comprises two release tabs, and wherein the release tabs are positioned on opposite sides of the vacuum cup.

17. The system of claim 12, wherein the vacuum nozzle and suction aperture are enclosed within the housing.

18. The system of claim 12, wherein the serving surface of the serving container is bowl shaped.

19. The system of claim 17, further comprising a lid configured to be removably coupled to the serving container to cover the serving surface.

20. The system of claim 12, wherein the male housing engaging element of the serving container is removably coupled to the male container engaging element of the housing with threading.
